(19) United States
(12) Patent Application Publication
(10) Pub. No.: US 2026/0188596 A1
(43) Pub. Date: Jul. 2, 2026

(54) SOLID ELECTROLYTIC CAPACITOR AND METHOD FOR MANUFACTURING SAME

(71) Applicant: Panasonic Intellectual Property Management Co., Ltd., Kadoma-shi, Osaka (JP)

(72) Inventor: Masanori Kashihara, SAGA KEN (JP)

(73) Assignee: Panasonic Intellectual Property Management Co., Ltd., Kadoma-shi, Osaka (JP)

(21) Appl. No.: 18/858,807

(22) PCT Filed: Apr. 20, 2023
(86) PCT No.: PCT/JP2023/015829

§ 371 Date: Oct. 22, 2024

(30) Foreign Application Priority Data
Apr. 28, 2022 (JP) 2022-074683

(51) Int. Cl. H01G 9/15; H01G 9/00; H01G 9/012; H01G 9/08

(52) U.S. Cl. CPC H01G 9/012; H01G 9/0029; H01G 9/08; H01G 9/15

(57) ABSTRACT

A solid electrolytic capacitor 100 disclosed includes a capacitor element 110 having an anode portion 111 and a cathode portion 115, a metallic lead frame 200, and an exterior body 140 covering the capacitor element 110. A portion of the lead frame 200 is an embedded portion 201 embedded in the exterior body 140. The lead frame 200 has an oxidized surface region on at least a portion of a surface of the embedded portion 201 in a direction in which the lead frame extends inward and outward from the exterior body 140. The oxidized surface region has a plurality of recesses 201c, and the degree of oxidation on surfaces of the plurality of recesses 201c is higher than the degree of oxidation in regions between the plurality of recesses 201c.

### TECHNICAL FIELD

The present disclosure relates to a solid electrolytic capacitor and a method for manufacturing the same.

### BACKGROUND ART

Solid electrolytic capacitors are mounted in a variety of electronic devices. A capacitor element, which is a main part of a solid electrolytic capacitor, includes an anode portion, a dielectric layer, and a cathode portion. Properties of the capacitor element deteriorate when the capacitor element comes into contact with oxygen or moisture. In particular, a solid electrolyte layer drastically deteriorates due to influences of oxygen or moisture.

A surrounding region of the capacitor element is covered with an exterior body containing resin. However, even when the capacitor element is covered with the exterior body, oxygen or moisture can enter the capacitor element through various routes, causing the electrolyte layer to deteriorate. Conventionally, measures for suppressing such deterioration have been proposed.

PTL 1 discloses “a solid electrolytic capacitor in which a capacitor element is formed by successively forming a dielectric polymer layer and a dielectric layer on a predetermined portion of a dielectric, the dielectric being an anodized oxide film formed on a plate or a foil made of a valve metal, a lead frame, which will be a lead-out terminal, is connected to a conductor layer portion and the valve metal portion of the capacitor element, the capacitor element and a portion of the lead frame are covered with a molded resin, a solder alloy layer or a tin metal layer having a copper metal layer as a base layer is formed on a surface of the lead frame other than a portion that is in contact with the molded resin, only a copper metal layer is formed on the lead frame portion that is in contact with the molded resin, and a surface of the copper metal layer is roughened”.

### CITATION LIST

### Patent Literature

PTL 1: Japanese Laid-Open Patent Publication No. H5-021290

### SUMMARY OF INVENTION

### Technical Problem

In recent years, there has been demand for further improvement in the reliability (e.g., stability of performance) of solid electrolytic capacitors. In such a situation, one object of the present disclosure is to provide a highly reliable solid electrolytic capacitor.

### Solution to Problem

In view of the above, one aspect of the present disclosure relates to a solid electrolytic capacitor including: a capacitor element having an anode portion and a cathode portion; a metallic lead frame; and an exterior body covering the capacitor element, in which a portion of the lead frame is an embedded portion embedded in the exterior body, the lead frame has an oxidized surface region on at least a portion of a surface of the embedded portion in a direction in which the lead frame extends inward and outward from the exterior body, the oxidized surface region has a plurality of recesses, and a degree of oxidation on surfaces of the plurality of recesses is higher than a degree of oxidation in regions between the plurality of recesses.

In view of the above, another aspect of the present disclosure relates to a solid electrolytic capacitor including: a capacitor element having an anode portion and a cathode portion; a metallic lead frame; and an exterior body covering the capacitor element, in which a portion of the lead frame is an embedded portion embedded in the exterior body, the lead frame has an oxidized surface region on at least a portion of a surface of the embedded portion in a direction in which the lead frame extends inward and outward from the exterior body, an oxidation level in the oxidized surface region is higher than an oxidation level in a surface of the lead frame other than the oxidized surface region, the oxidation level is represented by a ratio R=N_{O}/(N_{M}+N_{O}) of the number of oxygen atoms No calculated by performing energy dispersive X-ray analysis (EDS) using an electron beam with an acceleration voltage of 5 kV to a sum of the number of oxygen atoms N_{O} and the number of atoms of a metal element N_{M} that constitutes the lead frame, and the ratio R in the oxidized surface region is 0.45 or more.

In view of the above, yet another aspect of the present disclosure relates to a method for manufacturing a solid electrolytic capacitor, including: a step (i) of preparing a capacitor element having an anode portion and a cathode portion; a step (ii) of preparing a lead frame extending in a first direction and having an embedded portion at one end portion extending in the first direction; a step (iii) of connecting the embedded portion of the lead frame to the capacitor element; a step (iv) of covering the embedded portion and the capacitor element with an exterior body; and a surface oxidation step of forming a plurality of recesses in at least a portion of a surface of the embedded portion, and oxidizing at least a portion of surfaces of the plurality of recesses at a high temperature to form an oxidized surface region, after the step (ii) of preparing a lead frame and before the step (iii).

### Advantageous Effects of Invention

According to the present disclosure, it is possible to obtain a highly reliable solid electrolytic capacitor.

While novel features of the present invention are set forth particularly in the appended claims, the present invention, both as to organization and content, will be better understood and appreciated, along with other objects and features thereof, from the following detailed description taken in conjunction with the drawings.

### BRIEF DESCRIPTION OF DRAWINGS

FIG. 1 A cross-sectional view schematically showing a solid electrolytic capacitor of Embodiment 1.

FIG. 2A Atop view schematically showing an example of the arrangement of recesses in this embodiment.

FIG. 2B A diagram schematically showing a cross section taken along line IIB-IIB in FIG. 2A.

FIG. 3 A top view showing another example of the arrangement of a plurality of recesses.

FIG. 4 A cross-sectional view schematically showing a solid electrolytic capacitor of Embodiment 2.

### DESCRIPTION OF EMBODIMENTS

Although embodiments of a solid electrolytic capacitor according to the present disclosure will be described below using examples, the present disclosure is not limited to the examples described below. Although specific numerical values and materials may be mentioned as examples in the following description, other numerical values and other materials may be used as long as effects of the present disclosure can be obtained. The term “range of numerical value A to numerical value B” used in this specification includes the numerical value A and the numerical value B, and can be read as “range of numerical value A or more to numerical value B or less”. In the following description, when lower limits and upper limits of numerical values regarding specific physical properties, conditions, or the like are given as examples, any of the above-mentioned lower limits and any of the above-mentioned upper limits can be combined as desired, as long as the lower limit is not greater than or equal to the upper limit. A solid electrolytic capacitor may be referred to as an “electrolytic capacitor” or a “capacitor” hereinafter.

Also, the present disclosure encompasses combinations of items respectively recited in two or more claims selected from the attached claims. That is to say, it is possible to combine items respectively recited in two or more claims selected from the attached claims, as long as no technical contradiction arises.

### (Solid Electrolytic Capacitor)

A solid electrolytic capacitor according to an embodiment of the present disclosure includes a capacitor element having an anode portion and a cathode portion, a metallic lead frame, and an exterior body covering the capacitor element. A portion of the lead frame is an embedded portion embedded in the exterior body, and the remaining portion is a non-embedded portion (exposed portion) disposed outside the exterior body. The lead frame has an oxidized surface region on at least a portion of the surface of the embedded portion in a direction in which the lead frame extends inward and outward from the exterior body. An oxidation level in the oxidized surface region is higher than an oxidation level on the surface of the lead frame other than the oxidized surface region.

By oxidizing the surface of the lead frame in the embedded portion to form the oxidized surface region, the adhesion between the lead frame and the exterior body in the oxidized surface region is improved. This makes it possible to suppress deterioration of the electrolyte layer caused by the entry of oxygen or the like. As a result, deterioration of the capacitor element can be suppressed, and a highly reliable solid electrolytic capacitor can be obtained.

The reason why the oxidized surface region improves adhesion is thought to be, but not limited to, that oxygen present on the surface of the metallic lead frame can form bonds (including intermolecular interactions) with functional groups of an organic polymer that forms the exterior body, thus increasing bond strength between the lead frame and the exterior body.

In an embodiment, the oxidized surface region may have a plurality of recesses. The plurality of recesses are formed through, for example, irradiation with a laser beam (e.g., a pulsed laser beam) in an atmosphere containing oxygen (e.g., in the air). The plurality of recesses may be grooves extending along predetermined straight lines or curved lines in the oxidized surface region. A plurality of spot-like recesses may be dispersed in the oxidized surface region.

Through laser irradiation, a constituent metal of the lead frame in the region irradiated with the laser beam is rapidly heated and melted, and part of the metal evaporates, forming recesses. By irradiating the surface of the lead frame with the laser beam multiple times while changing the irradiation position, a plurality of spot-like recesses are formed. By continuously irradiating the surface of the lead frame with the laser beam while moving the irradiation position, a groove-shaped recess according to the locus of the irradiation position is formed. Alternatively, if the distance between centers of the multiple spot-like recesses is shorter than the diameter of the recesses to be formed, adjacent recesses may be connected to each other to form a groove-shaped recess.

At this time, the constituent metal of the lead frame is oxidized due to the rapid heating. On the other hand, on the surface of the lead frame that is not irradiated with a laser beam, oxidation of the constituent metal of the lead frame is suppressed. As a result, the degree of oxidation on the surfaces of the plurality of recesses is higher than the degree of oxidation in regions between the plurality of recesses. Note that the “degree of oxidation” above does not necessarily mean the oxidation level (ratio R) calculated by EDS, which will be described later.

The recesses roughen the surface of the lead frame, increasing the contact area between the lead frame and the exterior body, and the anchor effect improves adhesion between the lead frame and the exterior body. In addition, since the recesses are oxidized, oxygen present on the surfaces of the recesses can form bonds with functional groups of the organic polymer that constitutes the exterior body, thereby increasing the bond strength between the lead frame and the exterior body and improving the adhesion between the lead frame and the exterior body.

Compared to surface roughening through sandblasting, etching, or the like, the formation of recesses through irradiation with a laser beam can reduce variation in the shape and the size of the recesses, thereby ensuring stable adhesion (airtightness) between the lead frame and the exterior body. Further, because the size of the recesses can be controlled in accordance with the size of the insulating filler in the exterior body or the conductive particles in the conductive adhesive layer, it is possible to further improve the above-mentioned adhesion (airtightness). It is also possible to improve the above-mentioned adhesion (airtightness) by changing the size, shape, and arrangement pattern of the recesses depending on their positions.

When the plurality of recesses are in the form of spots, an average diameter D1 of the plurality of spot-like recesses may be 5 μm or more, 10 μm or more, or 30 μm or more, and may be 200 μm or less, 100 μm or less, or 75 μm or less. The average diameter D1 may be in a range of 5 μm to 200 μm (e.g., in a range of 10 μm to 100 μm). The average diameter D1 is determined by arithmetically averaging the diameters of openings of the plurality of recesses.

An equivalent circle diameter can be used as the diameter of the opening of each recess. The equivalent circle diameter can be determined using the following method. First, an image of the opening of a recess is taken from above. Then, the area of the opening is determined by subjecting the obtained image to image processing. Thereafter, the equivalent circle diameter is calculated from the determined area. The average diameter D1 can be determined by calculating the diameter (equivalent circle diameter) of the opening of each of 20 recesses selected suitably and arithmetically averaging the calculated diameters.

By forming recesses using a laser beam, it is possible to form recesses with a uniform size and shape at desired positions. For example, the diameter of the opening of each recess can be controlled to be in a range of 50% to 150% of the average diameter D1.

The spot-like recesses may include recesses having circular openings or recesses having non-circular openings, or include both recesses having circular openings and recesses having non-circular openings. Examples of recesses having non-circular openings include recesses obtained by forming a plurality of recesses having circular openings such that they partially overlap each other. Examples of non-circular shapes include two adjacent circles that slightly overlap each other, and two adjacent circles that mostly overlap each other. Examples of non-circular shapes also include the shape of a locus that occurs when a circle is shifted. Examples of non-circular shapes include elliptical, elongate circular, oval, and substantially triangular shapes.

When the plurality of recesses are groove-shaped, the width of the plurality of groove-shaped recesses may be 5 μm or more, 10 μm or more, or 20 μm or more, and may be 200 μm or less, 50 μm or less, or 30 μm or less. For example, the width may be 5 μm or more and 50 μm or less. The width of a recess is the width of the opening of the recess, and means the maximum length of the opening in a direction perpendicular to the direction in which the groove-shaped portion extends (the longitudinal direction in the case of a straight groove).

The length of the opening of the groove-shaped recess may be 15 μm or more, 50 μm or more, 100 μm or more, or 1 mm or more. There is no particular limitation on the upper limit of the length, and the recess may be formed across the entire width of the lead frame. That is, the length may be less than or equal to the width of the lead frame. The length depends on the size of an electrolytic capacitor, but the length may be 10 mm or less, 1 mm or less, or 100 μm or less.

The groove-shaped recess may be a straight groove or a non-straight groove. Examples of the non-straight groove include grooves with openings having a zigzag or wavy shape.

The depth of the plurality of recesses may be 0.5 μm or more, 2 μm or more, or 10 μm or more, and may be 100 μm or less, 50 μm or less, or 30 μm or less. For example, the depth of the recesses may be 2 μm or more and 50 μm or less. The depth of the recesses can be changed by, for example, adjusting the output of the laser beam used for irradiation to form the recesses.

In the oxidized surface region having the plurality of recesses, regions between the plurality of recesses are not oxidized, and the metal surface is maintained. Thus, even when the lead frame and the capacitor element are electrically connected to each other in the oxidized surface region, an increase in ESR caused by electrical connection is suppressed.

The oxidation level in a predetermined region of the surface of the lead frame can be evaluated through energy dispersive X-ray analysis (EDS: Energy Dispersive X-ray Spectroscopy).

In EDS, the surface of a sample is irradiated with an electron beam, and element-specific characteristic X-rays emitted after excitation by the electron beam are analyzed, thereby obtaining information regarding the distribution of elements contained in the surface of the sample. When the acceleration energy of the electron beam is 5 kV, it is possible to obtain information regarding the distribution of elements in a surface layer region up to a depth of approximately 500 nm from the surface.

In a predetermined region of the surface of the lead frame, the number of oxygen atoms No and the number of atoms of metal elements NM constituting the lead frame are determined through EDS using an electron beam with an acceleration voltage of 5 kV In this case, the oxidation level in the predetermined region can be evaluated using a ratio R=N_{O}/(N_{M}+N_{O}) of the number of oxygen atoms N_{O} to the sum of the number of oxygen atoms N_{O} and the number of atoms of the metal elements N_{M}. The ratio R is determined by averaging values at 10 or more measurement points selected suitably in the predetermined region.

For example, when the lead frame contains copper (Cu), the above ratio R as the oxidation level when a natural oxide film is formed on the surface of the lead frame, is at most 0.2 (20%) or less, and typically 0.1 (10%) or less.

In contrast, the ratio R as the oxidation level in the oxidized surface region may be 0.45 (45%) or more in one non-limiting embodiment. In this case, the adhesion between the lead frame and the exterior body is improved, and it is possible to suppress the entry of oxygen and the like. As a result, deterioration of the capacitor element can be significantly suppressed, and the reliability of the solid electrolytic capacitor can be maintained at a high level.

Meanwhile, if the surface of the lead frame in a region electrically connected to the capacitor element is oxidized, the contact resistance between the capacitor element and the lead frame increases, and the ESR of the electrolytic capacitor is likely to increase. However, as a result of intensive studies, it has been found that when the above ratio R is 0.27 (27%) or less, even when the surface of the lead frame in the region electrically connected to the capacitor element is oxidized, the associated effect on the ESR is small, and an increase in ESR is suppressed. However, when the above ratio R is 0.3 (30%) or more, a noticeable increase in ESR occurs by the surface of the lead frame in the region electrically connected to the capacitor element being oxidized.

Therefore, in the connection region of the surface of the lead frame that is electrically connected to the capacitor element, the ratio R as the oxidation level is preferably 0.27 (27%) or less. It is more preferable that an intentional oxidation process is not performed on the connection region (except for the case where a natural oxide film is formed).

The method for forming the oxidized surface region is not limited to the method for forming the plurality of recesses through laser irradiation, and the oxidized surface region may be formed through thermal oxidation. For example, by placing at least a portion of the lead frame in an oxygen-containing atmosphere (e.g., in the air) at 360° C. for 6 minutes or more, it is possible to form an oxidized surface region where the above ratio R as the oxidation level is 0.45 (45%) or more. The oxidation level can be controlled by the temperature and the processing time in thermal oxidation.

An example of EDS measurement conditions when calculating the above ratio R as the oxidation level is shown below.
Acceleration energy: 5 kV
Measurement region: 400 μm×400 μm
Measuring device: JSM-ITM500HR manufactured by JEOL (JEOL Ltd.)

When the oxidation level of the oxidized surface region having the above-mentioned plurality of recesses is evaluated through EDS, the measurement region measured by one instance of electron beam irradiation may include a plurality of recesses. In this case, the above ratio R as the oxidation level of the oxidized surface region having the plurality of recesses is calculated as an average value of the degree of oxidation in the plurality of recesses and the degree of oxidation in a (non-oxidized) region between the plurality of recesses, and it is difficult to determine the above ratio R as the oxidation level in consideration of only the recesses. However, even in this case, when the oxidation level of the region having the plurality of recesses is compared with the oxidation level of the region where no recesses are formed, the degree of oxidation of the recesses is higher than that in the region with no recesses, and thus the oxidation level of the region having the plurality of recesses is higher than that in the region with no recesses.

As for the surface of the lead frame, the oxidized surface region is provided on at least the surfaces of some of embedded portions embedded in the exterior body, and functions to improve adhesion between the lead frame and the exterior body. On the other hand, the oxidized surface region provided on the surfaces of non-embedded portions of the lead frame other than the embedded portions does not contribute to improving adhesion, since the surfaces are exposed from the exterior body. The oxidized surface region does not need to be provided on the surfaces of the lead frame exposed from the exterior body, but the case where the oxidized surface region is provided is not excluded. When the oxidized surface region having the plurality of recesses is formed, recesses do not need to be formed in the surfaces of the lead frame exposed from the exterior body, but the case where recesses are formed is not excluded. A recess may be formed in the surface of the lead frame exposed from the exterior body, or no recess may be formed.

In order to effectively suppress the entry of oxygen and the like through the surface of contact between the lead frame and the exterior body, the oxidized surface region preferably includes at least an end region of the embedded portion on the surface side of the exterior body. The end region is a part positioned most upstream in the path of the entry of oxygen and the like into a capacitor, and by improving the adhesion of the end region to the exterior body, the path of the entry of oxygen and the like is effectively blocked, thus suppressing deterioration of the capacitor element.

The end region includes a boundary between the embedded portion and the exposed portion of the lead frame that is exposed from the exterior body, and is a region extending from the boundary toward the exterior body. The length of the end region in the direction in which the lead frame extends inward and outward from the exterior body is, for example, in a range of 0.1 mm to 3.5 mm or 0.1 mm to 1.5 mm.

In manufacturing of an electrolytic capacitor, an oxidized surface region may be formed to extend over the above boundary between the embedded portion and the exposed portion of the lead frame from the exterior body, such that the boundary is reliably included in the oxidized surface region, in consideration of variation in positioning that may occur when placing a capacitor element on the lead frame. In this case, the oxidized surface region includes an end region on the exterior body side of a surface of the lead frame that is exposed from the exterior body.

The oxidized surface region may be provided on the entire surface of the lead frame or may be provided on at least a portion of the surface of the embedded portion of the lead frame (e.g., the surface including the above end region). As described above, when the above ratio R as the oxidation level is 0.27 (27%) or less in the connection region where the lead frame is electrically connected to the capacitor element, an increase in ESR is suppressed. Therefore, the surface of the connection region may be oxidized to form an oxidized surface region, so that the above ratio R is 0.27 (27%) or less. However, in terms of reducing ESR, it is preferable to keep the oxidation level in the connection region low and not to perform a process to form recesses, or to maintain an oxidation level at which only a natural oxide film is formed, without performing an intentional oxidation process.

A plurality of regions having different ratios R may be present in the oxidized surface region.

The surfaces of non-embedded portions of the lead frame other than the embedded portions are exposed from the exterior body, and thus the oxidized surface region provided on the surfaces of non-embedded portions does not contribute to improving adhesion. Thus, apart from the end region on the exterior body side of the exposed portion, there is no need to increase the ratio R in the surface region of the lead frame other than the embedded portions, and the ratio R may be 0.27 (27%) or less. The ratio R in the surface region of the lead frame other than the oxidized surface region may be 0.27 (27%) or less.

In contrast, the ratio R on the surface of the embedded portion of the lead frame in a region other than the connection region where the lead frame and the capacitor element are electrically connected to each other is preferably 0.45 (45%) or more from the viewpoint of improving the adhesion between the lead frame and the exterior body.

More specifically, the lead frame may include an anode lead frame that is electrically connected to the anode portion and a cathode lead frame that is electrically connected to the cathode portion. An embedded portion (first embedded portion) in the anode lead frame is provided with a connection region (first connection region) that is electrically connected to the anode portion. An embedded portion (second embedded portion) in the cathode lead frame is provided with a connection region (second connection region) that is electrically connected to the cathode portion. As for at least the second connection region that is electrically connected to the cathode portion, it is preferable to maintain the above ratio R as the oxidation level at a low ratio of 0.27 (27%) or less in order to reduce ESR, and when forming a plurality of recesses in the oxidized surface region through laser irradiation, it is preferable to keep the oxidation level of the connection region low or not to form recesses that are likely to be oxidized.

(Example of Configuration of Solid Electrolytic Capacitor) Examples of the configuration and constituent elements of a solid electrolytic capacitor according to this embodiment will be described below. Note that the configuration and constituent elements of the solid electrolytic capacitor according to this embodiment are not limited to the following examples. An example of the solid electrolytic capacitor according to this embodiment includes a capacitor element, an anode lead frame, a cathode lead frame, and an exterior body. These constituent elements will be described below.

### (Capacitor Element)

The capacitor element includes an anode portion, a dielectric layer, and a cathode portion. There is no particular limitation on the capacitor element, and a capacitor element used in a known solid electrolytic capacitor may be used.

The anode portion may be constituted by an anode body, or may include an anode body and an anode wire. The anode body may be a porous sintered body or a metal foil having a porous surface. The dielectric layer is formed on the surface of the anode body. The cathode portion includes an electrolyte layer (solid electrolyte layer) and a cathode layer. The electrolyte layer is arranged between the dielectric layer formed on the surface of the anode body and the cathode layer. There is no particular limitation on these constituent elements, and constituent elements used in a known solid electrolytic capacitor may be used. Examples of these constituent elements will be described below.

### (Anode Body)

The anode body may be formed by sintering particles, which can be used as a material of the anode body. Examples of the particles which can be used as the material include particles of a valve action metal, particles of an alloy containing a valve action metal, and particles of a compound containing a valve action metal. Only one type of these particles may be used, or two or more types thereof may be used in combination. Alternatively, a metal foil having valve action may be used as an anode body. Examples of the valve action metal include titanium (Ti), tantalum (Ta), niobium (Nb), aluminum (Al), and the like. A preferable example of the anode body, which is a sintered body, is a sintered body made of tantalum. A preferable example of the anode body, which is a metal foil, is an aluminum foil.

There is no particular limitation on the dielectric layer formed on the surface of the anode body, and the dielectric layer may be formed using a known method. For example, the dielectric layer may be formed by anodizing the surface of the anode body.

### (Anode Wire)

A wire made of metal can be used as an anode wire. Examples of the material of the anode wire include the above valve action metals, copper, and aluminum alloys. A portion of the anode wire is embedded in the anode body, and the remaining portion protrudes from an end surface of the anode body.

### (Electrolyte Layer)

There is no particular limitation on the electrolyte layer (solid electrolyte layer), and a solid electrolyte layer used in a known solid electrolytic capacitor may be used. The electrolyte layer is disposed to cover at least a portion of the dielectric layer. The electrolyte layer may be formed using a manganese compound or a conductive polymer. Examples of the conductive polymer include polypyrrole, polythiophene, polyaniline, and derivatives thereof. These conductive polymers may be used alone or in combination of two or more types. The conductive polymer may also be a copolymer of two or more types of monomers. Note that a derivative of a conductive polymer means a polymer having the conductive polymer as a basic structure. For example, examples of polythiophene derivatives include poly(3,4-ethylenedioxythiophene).

It is preferable that a dopant is added to the conductive polymer. The dopant can be selected depending on the conductive polymer, and a known dopant (e.g., a polymer dopant) may be used. Examples of the dopants include naphthalenesulfonic acid, p-toluenesulfonic acid, polystyrene sulfonic acid, and salts thereof. An exemplary electrolyte layer is formed using poly(3,4-ethylenedioxythiophene) (PEDOT) doped with polystyrene sulfonic acid (PSS).

The electrolyte layer containing a conductive polymer may be formed by polymerizing a monomer, which is a raw material, on the dielectric layer. Alternatively, the electrolyte layer may be formed by applying liquid containing the conductive polymer (and a dopant as needed) onto the dielectric layer and drying the liquid.

### (Cathode Layer)

The cathode layer is a conductive layer and disposed to cover at least a portion of the electrolyte layer. The cathode layer includes a conductive cathode extraction layer. The cathode layer may include another conductive layer (e.g., a carbon layer) disposed between the electrolyte layer and the cathode extraction layer. For example, the cathode layer may include a carbon layer formed on the electrolyte layer and a cathode extraction layer formed on the carbon layer. The cathode extraction layer may be formed using a metal paste (e.g., a silver paste) containing metal particles (e.g., silver particles) and a resin, or may be formed using a known silver paste. The carbon layer is a layer containing carbon, and may be formed using a conductive carbon material such as graphite and a resin.

### (Anode Lead Frame and Cathode Lead Frame)

The lead frames (the anode lead frame and the cathode lead frame) each include a substrate. The substrate is made of a metal (copper, a copper alloy, or the like). The thickness of the substrate is not particularly limited, and may be in a range of 25 μm to 200 μm (e.g., in a range of 25 μm to 100 μm). The lead frame may include a substrate and a plating layer formed on the substrate.

The plating layer may be made of a metal (including an alloy) such as nickel, gold, palladium, tin, or copper, and include a nickel layer, a gold layer, a palladium layer, a tin layer, a copper layer, or the like. For example, plating layers may be stacked on the substrate in the following order: a nickel layer, a gold layer, and a palladium layer. The plating layers can be formed using a known plating method.

When the surface of the substrate includes a plating layer, the surface of the substrate on which the plating layer is formed is irradiated with a laser beam, and thus the substrate is exposed from portions where recesses are formed. Therefore, the portions where the recesses are formed are more likely to be oxidized than portions where the plating layer is formed.

As described above, the lead frame is provided with the oxidized surface region. In the oxidized surface region, a plurality of recesses are formed through irradiation with a laser beam, and the surfaces of the recesses are oxidized. Alternatively, the surface of the oxidized surface region is oxidized by performing a thermal oxidation process or the like.

The anode lead frame is electrically connected to the anode portion. The anode lead frame includes the first embedded portion embedded in the exterior body, and the exposed portion exposed from the exterior body. The first embedded portion and the anode portion may be connected through welding or the like. At least a part of the exposed portion functions as a terminal part. The terminal part is apart where soldering or the like is performed.

The cathode lead frame is electrically connected to the cathode portion. The cathode lead frame includes the second embedded portion embedded in the exterior body, and the exposed portion exposed from the exterior body. The second embedded portion and the cathode portion may be connected by a conductive adhesive layer. At least apart of the exposed portion functions as a terminal part. The terminal part is a part where soldering or the like is performed.

### (Conductive Adhesive Layer)

The conductive adhesive layer that connects the second embedded portion of the cathode lead frame to the cathode portion contains conductive particles. Examples of the conductive particles include metal particles (e.g., silver particles). The conductive adhesive layer can be formed using a metal paste (e.g., silver paste) containing metal particles and a resin.

### (Exterior Body)

The exterior body is disposed in a surrounding region of the capacitor element such that the capacitor element is not exposed to the surface of the electrolytic capacitor. Further, the exterior body is disposed to cover the embedded portion of the anode lead frame and the embedded portion of the cathode lead frame. The exterior body usually contains a resin (insulating resin) and an insulating filler.

The exterior body can be made of a resin composition containing an insulating resin and an insulating filler (e.g., an inorganic filler). The resin composition may contain, in addition to the insulating resin and the insulating filler, a curing agent, a polymerization initiator, and/or a catalyst.

Examples of the insulating resin include insulating thermosetting resins and insulating thermoplastic resins. Specifically, examples of the insulating resin include epoxy resin, phenolic resins, urea resin, polyimide, polyamide-imides, polyurethane, diallyl phthalate, unsaturated polyester, polyphenylene sulfide (PPS), and polybutylene terephthalate (PBT).

Examples of the insulating filler include insulating particles and insulating fibers. Examples of an insulating material that constitutes the insulating filler include insulating compounds (oxides and the like) such as silica and alumina, glass, and mineral materials (talc, mica, clay, and the like). The exterior body may contain one or two or more types of insulating fillers.

(Method for Manufacturing Solid Electrolytic Capacitor) A method for manufacturing the solid electrolytic capacitor according to an embodiment of the present disclosure will be described below using examples. However, the solid electrolytic capacitor may be manufactured using a method other than the manufacturing method described below. The items described regarding the solid electrolytic capacitor according to this embodiment can also be applied to the manufacturing method below, and therefore, redundant descriptions thereof may be omitted. Items described regarding the manufacturing method below may also be applied to the solid electrolytic capacitor according to this embodiment.

The method for manufacturing a solid electrolytic capacitor according to an embodiment of the present disclosure includes: a step (i) of preparing a capacitor element having an anode portion and a cathode portion; a step (ii) of preparing a lead frame extending in a first direction and having an embedded portion at one end portion extending in the first direction; a step (iii) of connecting the embedded portion of the lead frame to the capacitor element; and a step (iv) of covering the embedded portion and the capacitor element with an exterior body. The manufacturing method further includes a surface oxidation step of forming a plurality of recesses in at least a portion of a surface of the embedded portion, and oxidizing at least a portion of surfaces of the plurality of recesses at a high temperature to form an oxidized surface region, after the step (ii) of preparing a lead frame and before the step (iii).

In the step (i), the capacitor element is prepared. A capacitor element having the structure already described can be used as the capacitor element to be prepared.

In the step (ii), the lead frame is prepared. The lead frame is usually constituted by an anode lead frame that is electrically connected to the anode portion of the capacitor element and a cathode lead frame that is electrically connected to the cathode portion of the capacitor element.

The anode lead frame and the cathode lead frame are each prepared.

The anode lead frame and the cathode lead frame have a shape extending in one direction (first direction in this embodiment), and the embedded portion is provided at one end portion in the first direction. Usually, the embedded portion and a portion other than the embedded portion (exposed portion or non-embedded portion) are separated from each other at a specific position in the first direction. Here, a direction from the embedded portion toward the exposed portion (i.e., the direction from the inside toward the outside of the exterior body in the manufactured solid electrolytic capacitor) is defined as the first direction. The exposed portion is located on the first direction side of a specific position, and the embedded portion is located opposite to the specific position in the first direction.

A connection region for electrically connecting the anode portion or the cathode portion of the capacitor element is provided in the embedded portion. The other end portions of the anode lead frame and the cathode lead frame that are located opposite to the embedded portions in the first direction form terminal parts (an anode terminal and a cathode terminal) of the manufactured solid electrolytic capacitor, and are used for electrical connection to external terminals.

Then, after the surface oxidation step is performed, in the step (iii), the embedded portions of the lead frame are connected to the capacitor element. Specifically, the embedded portion (first embedded portion) of the anode lead frame is electrically connected to the anode portion of the capacitor element and the embedded portion (second embedded portion) of the cathode lead frame is electrically connected to the cathode portion of the capacitor element. There is no particular limitation on a method for connecting these portions, and a known connection method may be used. For example, the first embedded portion may be connected to the anode portion through welding.

The embedded portion (second embedded portion) of the cathode lead frame is provided with a connection region (second connection region) for electrical connection to the cathode portion. The second embedded portion may be electrically connected to the cathode portion via a conductive adhesive layer containing conductive particles in the second connection region. Specifically, the cathode portion and the second embedded portion may be connected to each other using a metal paste. When recesses are formed in the surface of the second connection region of the surface of the second embedded portion, the conductive adhesive layer can enter the recesses.

In the step (iv), the embedded portions and the capacitor element are covered with the exterior body. The step (iv) can be carried out using a known method. Specifically, for example, the embedded portions and the capacitor element are covered with a resin composition, which will be the exterior body, and then the resin composition is cured. An exterior body containing a resin (insulating resin) and an insulating filler can be used as the exterior body. At this time, when recesses are formed in the oxidized surface region, the exterior body can enter the inside of the recesses.

### (Surface Oxidation Step)

After the step (ii) of preparing the lead frame and before the step (iii) of connecting the lead frame and the capacitor element to each other, a step of forming a plurality of recesses in at least a portion of the surfaces of the embedded portions is performed. At this time, at least a portion of the surfaces of the plurality of recesses is oxidized to form an oxidized surface region.

The plurality of recesses can be formed by irradiating the oxidized surface region with a laser beam in an atmosphere containing oxygen (e.g., in the air). A laser irradiation region in the oxidized surface region is heated through irradiation with the laser beam, which melts a constituent metal of the lead frame to form recesses, while the surfaces of the recesses are oxidized through heating.

All of the plurality of recesses may be formed under the same conditions (e.g., using the same laser beam). Alternatively, some of the plurality of recesses may be formed under different conditions (e.g., using different laser beams). In such a case, the recesses formed under different conditions may have different sizes and different shapes.

The plurality of recesses are formed in at least a portion of the surface of embedded portion. It is preferable that the plurality of recesses are formed in a region in the embedded portion that is adjacent to the exposed portion in the first direction (a region that will be an end region on the surface side of the exterior body in the manufactured electrolytic capacitor).

A plurality of recesses may also be formed in portion of the lead frame other than the embedded portion. The plurality of recesses may be formed in a region in the embedded portion that is adjacent to the exposed portion, and may also be formed in the region of the exposed portion that is adjacent to the embedded portion in the first direction. In this case, the plurality of recesses are formed in a region extending over the boundary between the exposed portion and the embedded portion.

In the steps (iii) and (iv), due to positioning variation when placing the capacitor element on the lead frame and the like, the boundary between the portion of the lead frame covered with the exterior body and the portion that is not covered therewith may shift from the boundary between the embedded portion and the exposed portion, and the boundary between the embedded portion and the exposed portion may be located inside the exterior body. In such a case, the portion of the exposed portion of the lead frame is also covered with the exterior body, and accordingly oxygen and the like are likely to enter through a gap between the exterior body and the exposed surface. By forming a plurality of recesses in some regions of the exposed portion in consideration of positioning variations to form oxidized surface regions, even when the boundary between the embedded portion and the exposed portion is located within the exterior body as described above, an end portion of a covered portion with the exterior body of the lead frame on the surface side of the exterior body will be the oxidized surface region, thereby improving the adhesion between the lead frame and the exterior body at the end portion and suppressing the entry of oxygen and the like.

On the other hand, in the exposed portion, end portions opposite to the embedded portion in the first direction (end portion of non-embedded portion) constitute terminal parts (anode terminal and cathode terminal) of the manufactured solid electrolytic capacitor. Therefore, from the viewpoint of reducing contact resistance between terminals and external terminals, it is preferable not to perform laser irradiation in the end portion of the exposed portion opposite to the embedded portion and not to form a plurality of recesses.

Also, the plurality of recesses may be formed in the entire surface of each embedded portion, or may be formed in a portion of the surface of the embedded portion. In the embedded portion, in order to maintain a low ESR, the connection region used for connection to the capacitor element does not need to be irradiated with a laser beam, and a plurality of recesses do not need to be formed in the connection region.

Recesses can be formed using a known laser processing device capable of forming recesses in metal. There is no particular limitation on a laser beam used for irradiation, as long as it is capable of forming a recess. The wavelength of the laser beam may be 1100 nm or less or 700 nm or less (e.g., 600 nm or less), or may be 300 nm or more (e.g., 350 nm or more). By using a laser beam with a short wavelength, it is possible to suppress an increase in the temperature of the lead frame when forming recesses. The wavelength of a laser beam may be 1064 nm (near infrared laser), 532 nm (visible laser), or 355 nm (ultraviolet laser). The plurality of recesses may be recesses formed through irradiation with a laser beam having a wavelength of 300 nm or more and 1100 nm or less (e.g., 300 nm or more and 600 nm or less).

The plurality of recesses may be formed by scanning with a laser beam. Alternatively, the recesses may be formed by moving a laser processing device and/or the lead frame.

The laser bean may be a pulsed laser beam or a continuous wave laser beam (CW laser beam). A recess having a circular opening may be formed through irradiation with a pulsed laser beam. A recess having a non-circular opening may be formed through multiple instances of irradiation with a pulsed laser beam such that irradiated portions partially overlap each other. Alternatively, a recess having a non-circular opening may be formed through irradiation with a CW laser beam (continuous wave laser beam).

A preferable example of the laser beam for forming recesses is a laser beam with a wavelength of 355 nm. There is no particular limitation on the light source of the laser beam with a wavelength of 355 nm, and a third harmonic such as a YVO₄ laser may be used.

An example of the solid electrolytic capacitor according to the present disclosure will be specifically described below with reference to the drawings. The above-described constituent elements can be applied to constituent elements of a capacitor in an example described below.

Also, the capacitor of the example described below can be modified based on the above description. The items described below may also be applied to the above embodiment. Further, in the embodiment described below, constituent elements that are not essential to the solid electrolytic capacitor according to the present disclosure may be omitted.

### Embodiment 1

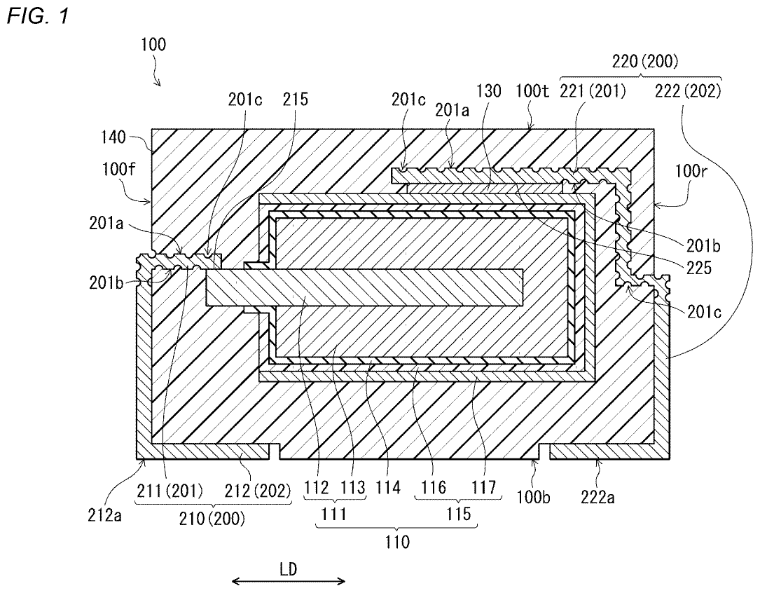

FIG. 1 schematically shows a cross-sectional view of a solid electrolytic capacitor 100 of Embodiment 1 (may be referred to as an “electrolytic capacitor 100” hereinafter). In Embodiment 1, an example in which an anode portion includes an anode body and an anode wire will be described.

The electrolytic capacitor 100 includes a capacitor element 110, lead frames 200, a conductive adhesive layer 130, and an exterior body 140. The lead frames 200 include an anode lead frame 210 and a cathode lead frame 220.

The capacitor element 110 includes an anode portion 111, a dielectric layer 114, and a cathode portion 115. The anode portion 111 includes an anode body 113 and an anode wire 112. The anode body 113 is a rectangular parallelepiped porous sintered body and has the dielectric layer 114 on its surface.

A portion of the anode wire 112 protrudes from one end surface of the anode body 113 toward a front face 100f of the electrolytic capacitor 100. The other portion of the anode wire 112 is embedded in the anode body 113. The anode wire 112 extends along a longitudinal direction LD of the anode body 113. The cathode portion 115 includes an electrolyte layer 116 disposed to cover at least a portion of the dielectric layer 114, and a cathode layer 117 formed to cover at least a portion of the electrolyte layer 116.

The anode lead frame 210 includes a first embedded portion 211 embedded in the exterior body 140, and an exposed portion 212 exposed from the exterior body 140. The exposed portion 212 includes a terminal part 212a that functions as an anode terminal. A face on which the terminal part 212a is present may be referred to as a “bottom face 100b” of the electrolytic capacitor 100. A face opposite to the bottom face 100b may be referred to as a “top face 100t” of the electrolytic capacitor 100. A face opposite to a front face 100f may be referred to as a “rear face 100r” of the electrolytic capacitor 100.

The cathode lead frame 220 includes a second embedded portion 221 embedded in the exterior body 140, and an exposed portion 222 exposed from the exterior body 140. The exposed portion 222 includes a terminal part 222a that functions as a cathode terminal. Hereinafter, the first embedded portion 211 and the second embedded portion 221 may be collectively referred to as embedded portions 201, and the exposed portion 212 and the exposed portion 222 may be collectively referred to as exposed portions 202. The lead frames 200 include the embedded portions 201 and the exposed portions 202.

Note that the overall shape and arrangement of the lead frames 200, and positions at which the lead frames 200 are connected to the anode portion 111 and the cathode portion 115 are not limited to the example shown in FIG. 1. For example, the cathode lead frame 220 may be connected to the cathode portion 115 at a portion other than the top face 100t side (e.g., a portion on the bottom face 100b side or a portion on the rear face 100r side).

Each embedded portion 201 has a first surface 201a that is in contact with the exterior body 140, and a second surface 201b that is in contact with the exterior body 140 and is opposite to the first surface 201a. The second surface 201b of the second embedded portion 221 is in contact with the conductive adhesive layer 130. The second surface 201b is electrically connected to the cathode portion 115 (more specifically, the cathode layer 117) by the conductive adhesive layer 130.

A plurality of recesses are spaced apart from each other by a distance in the surfaces of the embedded portions of the solid electrolytic capacitor according to this embodiment. In Embodiment 1, the plurality of recesses 201c are formed in the first surface 201a and the second surface 201b of the anode lead frame 210, and the first surface 201a and the second surface 201b of the cathode lead frame 220.

The plurality of recesses 201c are formed at least in end regions of the embedded portions 201 on the surface (the front face 100f and the rear face 100r) side of the exterior body 140. The plurality of recesses 201c can be formed in both the first surface 201a and the second surfaces 201b of each embedded portion 201. However, the plurality of recesses 201c do not need to be formed in a region of the second surface 201b of the first embedded portion 211 that is connected to the anode wire 112 (first connection region 215), and a region of the second surface 201b of the second embedded portion 221 that is in contact with the conductive adhesive layer 130 (second connection region 225). As shown in the example of FIG. 1, the plurality of recesses 201c may be formed in the entire first surface 201a of the embedded portion 201 and the entire second surface 201b of the embedded portion 201 other than the first connection region 215 and the second connection region 225.

The plurality of recesses 201c may also be formed in partial regions of the exposed portions 202. In the example shown in FIG. 1, the plurality of recesses 201c are formed in the first surfaces 201a and the second surfaces 201b in the end regions of the exposed portions 202 on the surface (front face 100f and rear face 100r) side of the exterior body 140. Accordingly, the plurality of recesses 201c are formed in regions extending over the boundaries between the embedded portions 201 and the exposed portions 202.

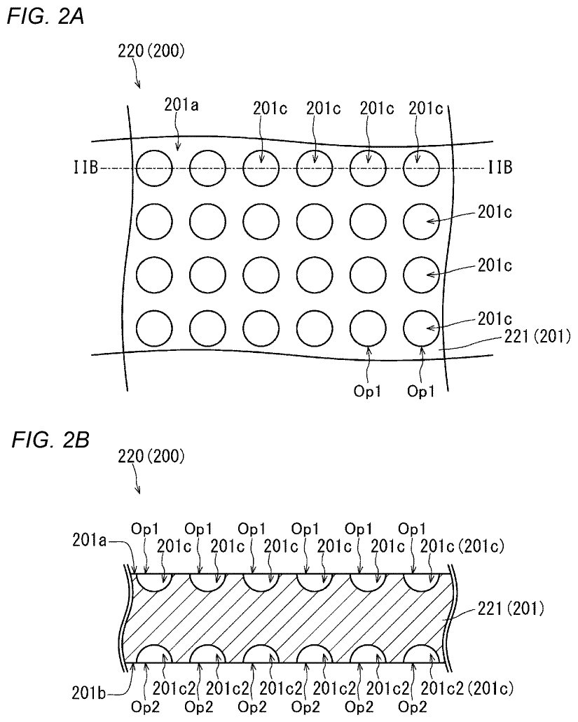

An example of the arrangement of the recesses 201c in the embedded portions 201 (first embedded portion 211 and second embedded portion 221) is shown in FIGS. 2A and 2B. FIG. 2A is a diagram of the embedded portion 201 as viewed from the top face 100t side. FIG. 2B shows across section taken along line IIB-IIB in FIG. 2A. In the example shown in FIG. 2A, the plurality of recesses 201c are arranged in a matrix at a fixed interval. In the examples shown in FIGS. 2A and 2B, the arrangement of the recesses 201c in one surface of the embedded portion 201 is similar to the arrangement of the recesses 201c in the other surface. However, the arrangement of the plurality of recesses 201c is not limited to the arrangements shown in FIGS. 2A and 2B, and may be other arrangements. Although the cross-sectional shape of the recesses 201c is schematically hemispherical in FIG. 2B, the cross-sectional shape of the recesses 201c need not be hemispherical. In the examples shown in FIGS. 2A and 2B, openings Op of the recesses 201c have a circular shape.

As described above, deterioration of the capacitor element 110 (e.g., an increase in ESR) can be suppressed by forming the recesses 201c. As a result, the reliability of the electrolytic capacitor 100 can be improved.

The distances between the plurality of recesses 201c arranged in a matrix may differ from each other depending on positions. For example, the distance between recesses 201c may be reduced in a region where adhesion needs to be improved and a region where prevention of the entry of oxygen and the like is particularly important. For example, the distance between recesses 201c in the end region of the embedded portion 201 on the surface side of the exterior body 140 may be narrower than the distance between recesses 201c in a region of the embedded portion 201 farther from the surface of the exterior body. On the other hand, when a plurality of recesses 201c are formed in the connection region 225 of the second embedded portion 221 that is in contact with the conductive adhesive layer 130, the distance between recesses 201c may be increased in order to suppress an increase in ESR.

The recesses 201c may be arranged in a matrix or may not be arranged in a matrix. The plurality of recesses 201c may also be arranged in a staggered manner.

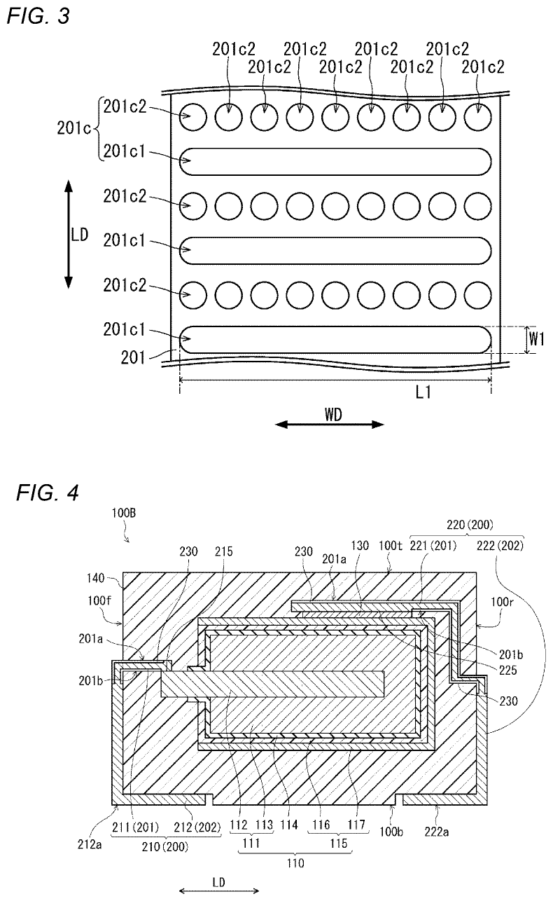

Some of the plurality of recesses 201c may include at least one groove-shaped first recess 201c1 and a plurality of non-groove-shaped second recesses 201c2. An example of the arrangement of such recesses 201c is shown in FIG. 3. In FIG. 3, the plurality of recesses 201c include the groove-shaped first recess 201c1 and the plurality of non-groove-shaped second recesses 201c2. The first recess 201c1 extends linearly along an intersection direction WD intersecting the longitudinal direction LD. The first recess 201c1 extends over almost the entire width of the embedded portion 201. FIG. 7 shows a length L1 of an opening of the first recess 201c1 along a direction in which the opening extends, and a width W1 of the opening.

Note that the groove-shaped first recess 201c1 extends linearly in the example shown in FIG. 3. However, at least one first recess 201ci does not need to be linear. The first recess 201c1 may be a groove extending in a zigzag manner.

### Embodiment 2

FIG. 4 schematically shows a cross-sectional view of a solid electrolytic capacitor 100B of Embodiment 2 (may be referred to as an “electrolytic capacitor 100B” hereinafter). Embodiment 2 is an example in which an oxidized surface region is formed through thermal oxidation of the surface of a lead frame, instead of forming a plurality of recesses 201c in a predetermined region of the surface of the lead frame in the configuration of Embodiment 1 shown in FIG. 1.

An oxidized surface region 230 (thermally oxidized layer) is formed on both a first surface 201a and a second surface 201b of the embedded portion 201 for each of the anode lead frame 210 and the cathode lead frame 220. The oxidized surface region 230 is also formed in an end region of an exposed portion 202 on the surface side of the exterior body 140 that is adjacent to the embedded portion 201. In the oxidized surface region 230, the oxidation level represented by the ratio R=N_{O}/(N_{M}+N_{O}) calculated through EDS is 0.45 or more.

On the other hand, in the second embedded portion 221, the oxidized surface region 230 is not formed on a portion of the second surface 201b that is in contact with a conductive adhesive layer 130 (connection region 225). Although a thermal oxidation process may also be performed on the connection region, it is preferable that the degree of oxidation is controlled such that the above ratio R is 0.27 (27%) or less.

### APPENDIX

The above description of the embodiments discloses the following techniques.

### (Technique 1)

A solid electrolytic capacitor comprising:
a capacitor element having an anode portion and a cathode portion;
a metallic lead frame; and
an exterior body covering the capacitor element,
in which a portion of the lead frame is an embedded portion embedded in the exterior body,
the lead frame has an oxidized surface region on at least a portion of the surface of the embedded portion in a direction in which the lead frame extends inward and outward from the exterior body,
the oxidized surface region has a plurality of recesses, and
a degree of oxidation on surfaces of the plurality of recesses is higher than a degree of oxidation in regions between the plurality of recesses.

### (Technique 2)

The solid electrolytic capacitor according to Technique 1,
in which the lead frame includes an anode lead frame that is electrically connected to the anode portion and a cathode lead frame that is electrically connected to the cathode portion,
the embedded portion in the cathode lead frame is provided with a connection region that is electrically connected to the cathode portion, and
the connection region does not have the oxidized surface region.

### (Technique 3)

The solid electrolytic capacitor according to Technique 1 or 2,
in which at least a portion of a surface of an exposed portion of the lead frame that is exposed from the exterior body does not have the oxidized surface region.

### (Technique 4)

The solid electrolytic capacitor according to any one of Techniques 1 to 3,
in which the oxidized surface region includes at least an end region of the embedded portion on a surface side of the exterior body, and is provided to extend over a boundary between the embedded portion and an exposed portion of the lead frame that is exposed from the exterior body.

### (Technique 5)

The solid electrolytic capacitor according to any one of Techniques 1 to 4,
in which the plurality of recesses have an average diameter of 5 μm to 200 μm.

### (Technique 6)

The solid electrolytic capacitor according to any one of Techniques 1 to 5,
in which an oxidation level is 0.45 or more, the oxidation level being represented by a ratio R=N_{O}/(N_{M}+N_{O}) of the number of oxygen atoms N_{O} calculated by performing, on the oxidized surface region, energy dispersive X-ray analysis (EDS) using an electron beam with an acceleration voltage of 5 kV to a sum of the number of oxygen atoms N_{O} and the number of atoms of a metal element N_{M} that constitutes the lead frame.

### (Technique 7)

A solid electrolytic capacitor comprising:
a capacitor element having an anode portion and a cathode portion;
a metallic lead frame; and
an exterior body covering the capacitor element,
in which a portion of the lead frame is an embedded portion embedded in the exterior body,
the lead frame has an oxidized surface region on at least a portion of a surface of the embedded portion in a direction in which the lead frame extends inward and outward from the exterior body,
an oxidation level in the oxidized surface region is higher than an oxidation level on a surface of the lead frame other than the oxidized surface region,
the oxidation level is represented by a ratio R=N_{O}/(N_{M}+N_{O}) of the number of oxygen atoms N_{O} calculated by performing energy dispersive X-ray analysis (EDS) using an electron beam with an acceleration voltage of 5 kV to a sum of the number of oxygen atoms N_{O} and the number of atoms of a metal element N_{M} that constitutes the lead frame, and
the ratio R in the oxidized surface region is 0.45 or more.

### (Technique 8)

The solid electrolytic capacitor according to Technique 7,
in which the lead frame includes an anode lead frame that is electrically connected to the anode portion and a cathode lead frame that is electrically connected to the cathode portion,
the embedded portion in the cathode lead frame is provided with a connection region for electrical connection to the cathode portion, and
the ratio R in the connection region is 0.27 or less.

### (Technique 9)

The solid electrolytic capacitor according to Technique 7 or 8,
in which the ratio R in a surface region of the lead frame other than the oxidized surface region is 0.27 or less.

### (Technique 10)

The solid electrolytic capacitor according to any one of Techniques 7 to 9,
in which the oxidized surface region includes at least an end region of the embedded portion on a surface side of the exterior body, and is provided to extend over a boundary between the embedded portion and an exposed portion of the lead frame that is exposed from the exterior body.

### (Technique 11)

A method for manufacturing a solid electrolytic capacitor, comprising:
a step (i) of preparing a capacitor element having an anode portion and a cathode portion;
a step (ii) of preparing a lead frame extending in a first direction and having an embedded portion at one end portion extending in the first direction;
a step (iii) of connecting the embedded portion of the lead frame to the capacitor element;
a step (iv) of covering the embedded portions and the capacitor element with an exterior body; and
a surface oxidation step of forming a plurality of recesses in at least a portion of a surface of the embedded portion, and oxidizing at least a portion of surfaces of the plurality of recesses at a high temperature to form an oxidized surface region, after the step (ii) of preparing a lead frame and before the step (iii).

### (Technique 12)

The method for manufacturing a solid electrolytic capacitor according to Technique 11,
in which in the surface oxidation step, the plurality of recesses are formed by irradiating the oxidized surface region with a laser beam.

### (Technique 13)

The method for manufacturing a solid electrolytic capacitor according to Technique 11 or 12,
in which in the surface oxidation step, laser irradiation is not performed on an end portion of a non-embedded portion of the lead frame located opposite to the embedded portion in the first direction.

### (Technique 14)

The method for manufacturing a solid electrolytic capacitor according to any one of Techniques 11 to 13,
in which in the step (ii) of preparing a lead frame, an anode lead frame and a cathode lead frame are prepared,
the embedded portion in the cathode lead frame is provided with a connection region for electrical connection to the cathode portion, and
laser irradiation is not performed on the connection region.

### Examples

The following describes the present invention in more detail based on examples and comparative examples, but the present invention is not limited to the following examples.

An electrolytic capacitor was fabricated as follows.

### (Formation of Anode Body)

Tantalum metal particles were used as the valve action metal. The tantalum metal particles were molded into a rectangular parallelepiped shape such that one end of an anode wire made of copper was embedded into the tantalum metal particles, and the molded body was sintered in a vacuum. Accordingly, an anode portion including an anode body formed from a porous sintered body made of tantalum and an anode wire having one end embedded in the anode body and the remaining portion extending from one surface of the anode body was obtained.

### (Formation of Dielectric Layer)

Then, the anode body and a portion of the anode wire extending from the anode body were immersed in a chemical conversion tank filled with an aqueous phosphoric acid solution serving as an electrolytic solution, and the other end of the anode wire was connected to the anode body in the chemical conversion tank. By performing anodization, a uniform dielectric layer made of tantalum oxide (Ta₂O₅) was formed on the surface of the anode body (the surface of the porous sintered body including the inner wall surfaces of pores) and a portion of the surface of the anode wire.

### (Formation of Solid Electrolyte Layer)

Next, a first solution was prepared by mixing 3,4-ethylenedioxythiophene, which is a raw material for the first conductive polymer, iron (III) p-toluenesulfonate, and 1-butanol. The anode body was immersed in the first solution, and the anode body was removed from the first solution and subjected to heat treatment in the air. In this case, iron (III) p-toluenesulfonate functions as an oxidizing agent. A first conductive polymer layer containing poly(3,4-ethylenedioxythiophene) (PEDOT) was formed on the dielectric layer in this manner.

Next, a second dispersion was prepared by mixing poly(3,4-ethylenedioxythiophene) as a second conductive polymer, a polystyrene sulfonate, and water. The anode body was immersed in the second dispersion, and the anode body was removed from the second dispersion and subjected to reduced pressure treatment. After the reduced pressure treatment was performed, drying treatment was performed at 80° C. for 20 minutes under atmospheric pressure to form a second conductive polymer layer. A solid electrolyte layer having two layers, namely, the first conductive polymer layer and the second conductive polymer layer, was formed on the dielectric layer in this manner.

### (Formation of Cathode Layer)

A carbon layer was formed on the surface of the solid electrolyte layer by applying a carbon paste. A silver paste layer was formed on the surface of the carbon layer by applying a silver paste thereto. A cathode layer constituted by the carbon layer and the silver paste layer was formed in this manner.

### (Fabrication of Electrolytic Capacitor)

Copper lead frames (anode lead frame and cathode lead frame) plated with three layers of Ni/Pd/Au were prepared.

A conductive adhesive was applied to the cathode layer, and the cathode lead frame was bonded to the cathode layer via the conductive adhesive. The anode wire and the anode lead frame were joined together through resistance welding.

Next, a capacitor element to which lead terminals have been joined and materials for the exterior body (uncured thermosetting resin and filler) were placed in a mold, and the capacitor element was encapsulated through transfer molding. After encapsulation, portions of the anode lead frame and the cathode lead frame that are exposed from the exterior body (exposed portions) were bent along the surface of the exterior body to obtain a solid electrolytic capacitor having the configuration shown in FIG. 1.

In this example, a plurality of recesses were formed by irradiating a predetermined region of the lead frame with a laser beam. A UV (ultraviolet) laser beam with a wavelength of 355 nm was used as the laser beam. The recesses were formed such that they had a depth of 20 μm and circular openings with an average diameter of 30 μm, and the distance between adjacent recesses was 50 μm.

A plurality of lead frames a1 to a5, and b1 having different regions irradiated with a laser beam were prepared. Electrolytic capacitors A1 to A5 and B1 were fabricated respectively using the lead frames alto a5 and b1, and the following evaluations were performed. The electrolytic capacitors A1 to A5 were examples, and the electrolytic capacitor B1 was a comparative example.

### (Lead Frame a1)

In the anode lead frame, both surfaces of the first embedded portion 211 (excluding both surfaces in the first connection region 215 connected to the anode wire 112) and both surfaces of the end region of the exposed portion 212 on the front face 100f side of the exterior body were irradiated with a laser beam, to form a plurality of recesses.

In the cathode lead frame, both surfaces of the second embedded portion 221 (excluding both surfaces in the second connection region 225 that is in contact with the conductive adhesive layer 130) and both surfaces of the end region of the exposed portion 222 on the rear face 100r side of the exterior body were irradiated with a laser beam, to form a plurality of recesses.

### (Lead Frame a2)

In the anode lead frame, both surfaces of the first embedded portion 211 (excluding both surfaces in the first connection region 215 connected to the anode wire 112) and both surfaces of the end region of the exposed portion 212 on the front face 100f side of the exterior body were irradiated with a laser beam, to form a plurality of recesses.

In the cathode lead frame, both surfaces of the second embedded portion 221 (in the second connection region 225 that is in contact with the conductive adhesive layer 130, only the first surface 201a on the opposite side to the second connection region 225) and both surfaces of the end region of the exposed portion 222 on the rear face 100r side of the exterior body were irradiated with a laser beam, to form a plurality of recesses.

### (Lead Frame a3)

In the anode lead frame, both surfaces of the first embedded portion 211 (in the connection region 215 connected to the anode wire 112, only the first surface 201a on the opposite side to the connection region 215) and both surfaces of the end region of the exposed portion 212 on the front face 100f side of the exterior body were irradiated with a laser beam, to form a plurality of recesses.

In the cathode lead frame, both surfaces of the second embedded portion 221 (in the second connection region 225 that is in contact with the conductive adhesive layer 130, only the first surface 201a on the opposite side to the second connection region 225) and both surfaces of the end region of the exposed portion 222 on the rear face 100r side of the exterior body were irradiated with a laser beam, to form a plurality of recesses.

### (Lead Frame a4)

In the anode lead frame, both surfaces of the first embedded portion 211 (excluding the first connection region 215 connected to the anode wire 112) and both surfaces of the end region of the exposed portion 212 on the front face 100f side of the exterior body were irradiated with a laser beam, to form a plurality of recesses.

In the cathode lead frame, both surfaces of the second embedded portion 221 (in the second connection region 225 that is in contact with the conductive adhesive layer 130, only the first surface 201a on the opposite side to the second connection region 225) and both surfaces of the end region of the exposed portion 222 on the rear face 100r side of the exterior body were irradiated with a laser beam, to form a plurality of recesses.

### (Lead Frame a5)

In the anode lead frame, the entirety of both surfaces of the first embedded portion 211 and both surfaces of the end region of the exposed portion 212 on the front face 100f side of the exterior body were irradiated with a laser beam, to form a plurality of recesses.

In the cathode lead frame, the entirety of both surfaces of the second embedded portion 221 and both surfaces of the end region of the exposed portion 222 on the rear face 100r side of the exterior body were irradiated with a laser beam, to form a plurality of recesses.

### (Lead Frame b1)

An anode lead frame and a cathode lead frame that were not irradiated with a laser beam were prepared and used as lead frames b1.

### Evaluation

In an environment at 20° C., the ESR value (mΩ) of the electrolytic capacitor at a frequency of 100 kHz was measured using an LCR meter for four-terminal measurement as the initial ESR value (X₀) (mΩ). Then, the electrolytic capacitor was heated at 270° C. for 3 minutes, and then continued to be heated at 145° C. The ESR value (X₁) (mΩ) of the electrolytic capacitor, 500 hours after the start of heating at 270° C. was measured using the same method as above. The rate of change in ESR, ΔX, was calculated using the equation below.

ΔX(%)=((X₁−X₀)/X₀)×100

The results of evaluating the ESR change rate is shown in Table 1. Examples 1 to 5 are A1 to A5, and Comparative Example 1 is B1. In Table 1, the ESR change rate is shown as a relative value ΔY where the change rate ΔX of B1 is set to 100.

TABLE 1

| Electrolytic Capacitor | ESR Change Rate Δ Y |
|---|---|
| A1 | 46 |
| A2 | 43 |
| A3 | 41 |
| A4 | 38 |
| A5 | 35 |
| B1 | 100 |

### INDUSTRIAL APPLICABILITY

The present disclosure can be used for a solid electrolytic capacitor and a method for manufacturing the same.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

100, 100B: solid electrolytic capacitor, 110: capacitor element, 111: anode portion, 113: anode body, 114: dielectric layer, 115: cathode portion, 116: electrolyte layer, 140: exterior body, 200: lead frame, 201: embedded portion, 201a: first surface, 201b: second surface, 201c: recess, 201c1: first recess, 201c2: second recess, 202, 212, 222: exposed portion, 210: anode lead frame, 211: first embedded portion, 212a, 222a: terminal part, 215: first connection region, 220: cathode lead frame, 221: second embedded portion, 225: second connection region, 230: oxidized surface region

1. A solid electrolytic capacitor comprising:
a capacitor element having an anode portion and a cathode portion;
a metallic lead frame; and
an exterior body covering the capacitor element,
wherein a portion of the lead frame is an embedded portion embedded in the exterior body,
the lead frame has an oxidized surface region on at least a portion of a surface of the embedded portion in a direction in which the lead frame extends inward and outward from the exterior body,
the oxidized surface region has a plurality of recesses, and
a degree of oxidation on surfaces of the plurality of recesses is higher than a degree of oxidation in regions between the plurality of recesses.

2. The solid electrolytic capacitor according to claim 1,
wherein the lead frame includes an anode lead frame that is electrically connected to the anode portion and a cathode lead frame that is electrically connected to the cathode portion,
the embedded portion in the cathode lead frame is provided with a connection region that is electrically connected to the cathode portion, and
the connection region does not have the oxidized surface region.

3. The solid electrolytic capacitor according to claim 1,
wherein at least a portion of a surface of an exposed portion of the lead frame that is exposed from the exterior body does not have the oxidized surface region.

4. The solid electrolytic capacitor according to claim 1,
wherein the oxidized surface region includes at least an end region of the embedded portion on a surface side of the exterior body, and is provided to extend over a boundary between the embedded portion and an exposed portion of the lead frame that is exposed from the exterior body.

5. The solid electrolytic capacitor according to claim 1,
wherein the plurality of recesses have an average diameter of 5 μm to 200 μm.

6. The solid electrolytic capacitor according to claim 1,
wherein an oxidation level is 0.45 or more, the oxidation level being represented by a ratio R=N_{O}/(N_{M}+N_{O}) of the number of oxygen atoms N_{O} calculated by performing, on the oxidized surface region, energy dispersive X-ray analysis (EDS) using an electron beam with an acceleration voltage of 5 kV to a sum of the number of oxygen atoms N_{O} and the number of atoms of a metal element N_{M} that constitutes the lead frame.

7. A solid electrolytic capacitor comprising:
a capacitor element having an anode portion and a cathode portion;
a metallic lead frame; and
an exterior body covering the capacitor element,
wherein a portion of the lead frame is an embedded portion embedded in the exterior body,
the lead frame has an oxidized surface region on at least a portion of a surface of the embedded portion in a direction in which the lead frame extends inward and outward from the exterior body,
an oxidation level in the oxidized surface region is higher than an oxidation level on a surface of the lead frame other than the oxidized surface region,
the oxidation level is represented by a ratio R=N_{O}/(N_{M}+N_{O}) of the number of oxygen atoms N_{O} calculated by performing energy dispersive X-ray analysis (EDS) using an electron beam with an acceleration voltage of 5 kV to a sum of the number of oxygen atoms N_{O} and the number of atoms of a metal element N_{M} that constitutes the lead frame, and
the ratio R in the oxidized surface region is 0.45 or more.

8. The solid electrolytic capacitor according to claim 7,
wherein the lead frame includes an anode lead frame that is electrically connected to the anode portion and a cathode lead frame that is electrically connected to the cathode portion,
the embedded portion in the cathode lead frame is provided with a connection region for electrical connection to the cathode portion, and
the ratio R in the connection region is 0.27 or less.

9. The solid electrolytic capacitor according to claim 7,
wherein the ratio R in a surface region of the lead frame other than the oxidized surface region is 0.27 or less.

10. The solid electrolytic capacitor according to claim 7,
wherein the oxidized surface region includes at least an end region of the embedded portion on a surface side of the exterior body, and is provided to extend over a boundary between the embedded portion and an exposed portion of the lead frame that is exposed from the exterior body.

11. A method for manufacturing a solid electrolytic capacitor, comprising:
a step (i) of preparing a capacitor element having an anode portion and a cathode portion;
a step (ii) of preparing a lead frame extending in a first direction and having an embedded portion at one end portion extending in the first direction;
a step (iii) of connecting the embedded portion of the lead frame to the capacitor element;
a step (iv) of covering the embedded portion and the capacitor element with an exterior body; and
a surface oxidation step of forming a plurality of recesses in at least a portion of a surface of the embedded portion, and oxidizing at least a portion of surfaces of the plurality of recesses at a high temperature to form an oxidized surface region, after the step (ii) of preparing a lead frame and before the step (iii).

12. The method for manufacturing a solid electrolytic capacitor according to claim 11,
wherein in the surface oxidation step, the plurality of recesses are formed by irradiating the oxidized surface region with a laser beam.

13. The method for manufacturing a solid electrolytic capacitor according to claim 11,
wherein in the surface oxidation step, laser irradiation is not performed on an end portion of a non-embedded portion of the lead frame located opposite to the embedded portion in the first direction.

14. The method for manufacturing a solid electrolytic capacitor according to claim 11,
wherein in the step (ii) of preparing a lead frame, an anode lead frame and a cathode lead frame are prepared,
the embedded portion in the cathode lead frame is provided with a connection region for electrical connection to the cathode portion, and
laser irradiation is not performed on the connection region.
